(19) United States
(12) Patent Application Publication
(10) Pub. No.: US 2006/0019222 A1
(43) Pub. Date: Jan. 26, 2006

(54) On-line educational course delivery system for medical and other applications

(76) Inventors: Lisa Fritsche Lelito, Phoenixville, PA (US); Natasha Harmuth, West Chester, PA (US); Margaret A. Feld, Christiana, PA (US); Ruth A. Dombroski, Malvern, PA (US); Kathy Kremin, Ardmore, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/152,431

(22) Filed: Jun. 14, 2005

Related U.S. Application Data
(60) Provisional application No. 60/579,918, filed on Jun. 14, 2004.

(51) Int. Cl. G09B 19/00

(52) U.S. Cl. 434/118; 434/219

(57) ABSTRACT

A system provides an on-line educational course concerning operation of a computerized information system. The system includes an interface processor, a data processor, and an assessment processor. The interface processor receives user identification information and assigns a role specific learning plan to an identified user. The data processor supports user exercise of role specific functions of a particular computerized information system in a test environment to accomplish predetermined objectives. The data processor supports user exercise of corresponding role specific functions of the particular computerized information system in an operational environment to accomplish the predetermined objectives. The assessment processor assesses a user proficiency level in accomplishing the predetermined objectives.

### CROSS-REFERENCE TO RELATED APPLICATIONS

The present application is a non-provisional application of provisional application having Ser. No. 60/579,918 filed by Lisa Fritsche Lelito, et al. on Jun. 14, 2004.

### FIELD OF THE INVENTION

The present invention generally relates to computer information systems. More particularly, the present invention relates to an on-line educational course delivery system for medical and other applications.

### BACKGROUND OF THE INVENTION

Computer information systems (“systems”) include computers that communicate with each other over a network, such as the Internet, and computers that manage information.

New users (e.g., students, learners, or consultants) of a system typically receive training and education to properly use the system. The training and education may include a series of classes comprising one course, covering a particular area of the system, or may include a series of courses leading to certification in one or more areas of the system.

Due to changes in the economy and advances in technology, professions have grown more complex. It has become difficult to evaluate an individual's ability to successfully perform the tasks required of a given profession. Corporate hiring decisions and based upon management's perception of an individual's ability to master the tasks of a specific job. The job to be filled may be new to the organization, and there is no organizational experience available to evaluate a candidate's true qualifications. Therefore, prospective employers have a need for certifications programs to objectively evaluate an individual.

Individuals also have a need for certification programs. By attaining professional certification, an individual in a given profession distinguishes himself from others in the same profession. This recognition provides the certified individual with an advantage over uncertified individuals in the profession in several areas. Certified individuals often find it easier to secure employment, earn higher salaries, and advance in their professions.

Typically, deployment managers for a system manually track information related to courses taken by consultants, which are delivered by a variety of instructors and in a variety of environments. The manual process uses manual exchanges of the information, and inconsistent and delayed approaches to managing, and tracking the performance and competency levels of the consultants. The manual process results in inconsistent tracking of performance and completion, and results in weak or absent testing.

Typically, practice managers for particular areas of the system are inconsistent in evaluating training and education needs of the consultants, lack automatic performance planning processes for the consultants, and lack tracking of competency levels for the consultants. Further, an absence of robust security prevents consultants from accessing critical areas of the system. Improper and inconsistent training of a consultant results in slow or delayed implementation of the system, and low or delayed revenue recognition for the provider of the system. Ultimately, customers of the system have the perception that the skills of consultants are incompetent and/or inconsistent.

Disadvantages of prior educational course delivery systems include an absence of one or more of the following aspects: automated gathering, management, tracking and reporting, global application deployment, consistent tracking of performance and competency levels, robust testing, robust security access to systems, practice environments, operational environments, board review, role specific learning plans, and structure and focus.

Accordingly, there is a need for an on-line educational course delivery system for medical and other applications that overcomes these and other disadvantages of the prior systems.

### SUMMARY OF THE INVENTION

A system provides an on-line educational course concerning operation of a computerized information system. The system includes an interface processor, a data processor, and an assessment processor. The interface processor receives user identification information and assigns a role specific learning plan to an identified user. The data processor supports user exercise of role specific functions of a particular computerized information system in a test environment to accomplish predetermined objectives. The data processor supports user exercise of corresponding role specific functions of the particular computerized information system in an operational environment to accomplish the predetermined objectives. The assessment processor assesses a user proficiency level in accomplishing the predetermined objectives.

### BRIEF DESCRIPTION OF THE DRAWINGS

FIG. 1 illustrates a certification program.

FIG. 2 illustrates a system for the certification program, as shown in FIG. 1.

FIG. 3 illustrates a method for the certification program, as shown in FIG. 1, and for the system, as shown in FIG. 2.

FIG. 4 illustrates a relationship between an academy and the certification program, as shown in FIG. 1.

FIG. 5 illustrates a progress report for clinical information system, common consulting foundation for a first student.

FIG. 6 illustrates progress report for clinical information system, financials consulting foundation for the first student.

FIG. 7 illustrates progress report for clinical information system, common financials product foundation for the first student.

FIG. 8 illustrates clinical information system, contracts and reimbursement product foundation for the first student.

FIG. 9 illustrates clinical information system, provider accounting product foundation for the first student.

FIG. 10 illustrates a course transcript report for clinical information system, contracts and reimbursement for the first student.

FIG. 11 illustrates a summary report for clinical information system, contracts and reimbursement for the first student.

FIG. 12 illustrates progress report for clinical information system, common consulting foundation for a second student.

FIG. 13 illustrates progress report for clinical information system, financials consulting foundation for the second student.

FIG. 14 illustrates progress report for clinical information system, common financials product foundation for the second student.

FIG. 15 illustrates progress report for clinical information system, contracts and reimbursement product foundation for the second student.

FIG. 16 illustrates progress report for clinical information system, provider accounting product foundation for the second student.

FIG. 17 illustrates a course transcript report for clinical information system, contracts and reimbursement for the second student.

FIG. 18 illustrates a summary report for clinical information system, contracts and reimbursement for the second student.

FIG. 19 illustrates a summary report for clinical information system, contracts and reimbursement for both the first and second students.

### DETAILED DESCRIPTION OF THE PREFERRED EMBODIMENTS

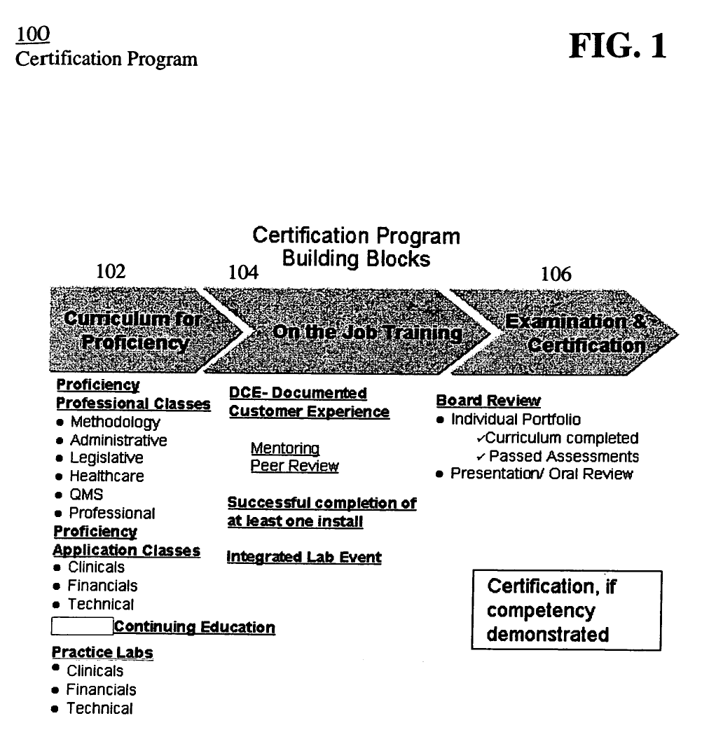

FIG. 1 illustrates a certification program 100 (“program”) provides a plan to train and educate users on how to use a computer information system. The program 100 may be used to plan and train users on how to use any type of application or environment including for example, medical or healthcare.

The program 100 includes, for example, a curriculum for proficiency 102, on the job training 104, and examination and certification 106. The program 100 permits a user to be certified after successful completion of the program 100, thereby demonstrating a user's competency of using the system 200.

The curriculum for proficiency 102 includes, for example, proficiency professional classes, proficiency application classes, continuing education, practice labs, and integrated labs. The proficiency professional classes further include, for example, methodology, administrative, legislative, healthcare, quality management system (QMS), and professional classes.

The proficiency application classes further include, for example, clinical, financial, and technical areas. Other areas may include customer support, development, and international consulting. Each of these areas is further subdivided into several role specific learning plans described, for example, as follows.

The clinical area further includes, for example, the following clinical roles: cardiology, team, clinical, and operational.

The financial area further includes, for example, the following financial roles: administrators for patients, accounting, contracts and reimbursement, and services.

The technical area further includes, for example, the following technical roles: cardiology technical advisor, cardiology technical implementer, clinical technical advisor, clinical technical implementer, financial technical advisor, clinical conversions technologist level 1, clinical conversions technologist level 2, clinical conversions technologist level 3, integration advisor, and integration technologist.

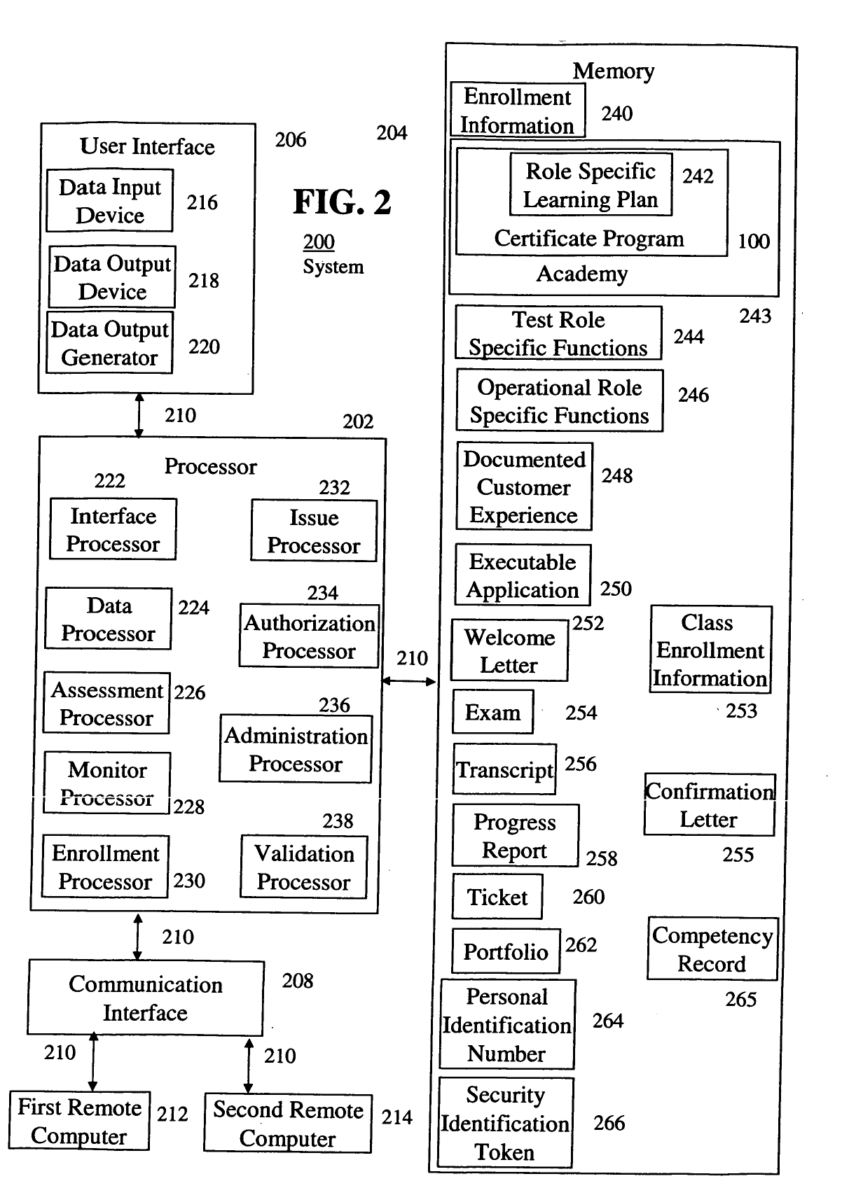

Each of the role specific learning plans is displayed in the academy 243 (FIG. 2) on individual candidate's portal. Each of the role specific learning plans has roll specific practice lab exercises, a roll specific documented customer experience form to be completed by a student, and a roll specific integrated lab event, each of which is further described with reference to FIG. 2.

The on the job training 104 includes a documented customer experience (DCE), completion of at least one installation on the system 200, and an integrated lab event in the system 200. The documented customer experience further includes mentoring and peer review.

The examination and certification 106 includes, a board review including a review of an individual portfolio and of a presentation or an oral exchange. The review of an individual portfolio further includes a completed curriculum and passed assessments.

FIG. 2 illustrates a system 200 for administering the certification program 100, as shown in FIG. 1. The system 200 includes a processor 202, a memory 204, a user interface 206, a communication interface 208, and a communication path 210. The processor 202 is electrically coupled to each of the memory 204, the user interface 206, and the communication interface 208 over the communication path 210. The system 200 interfaces to a first remote computer 212 and a second remote computer 214 via the communication interface 208 over the communication path 210.

The system 200 also comprises a computer information system that the student wishes to be certified for. Alternatively, the system for administering the certification program 100 and the computer information system that the student wishes to be certified for may be considered and deployed as two separate systems. In this alternative case, the student may access the computer information system via security measures, such as a web seal and a gateway.

The user interface 206 further includes a data input device 216, a data output device 218, and an output generator 220.

The processor 202 further includes, for example, an interface processor 222, a data processor 224, an assessment processor 226, a monitor processor 228, an enrollment processor 230, an issue processor 232, an authorization processor 234, an administration processor 236, and a validation processor 238.

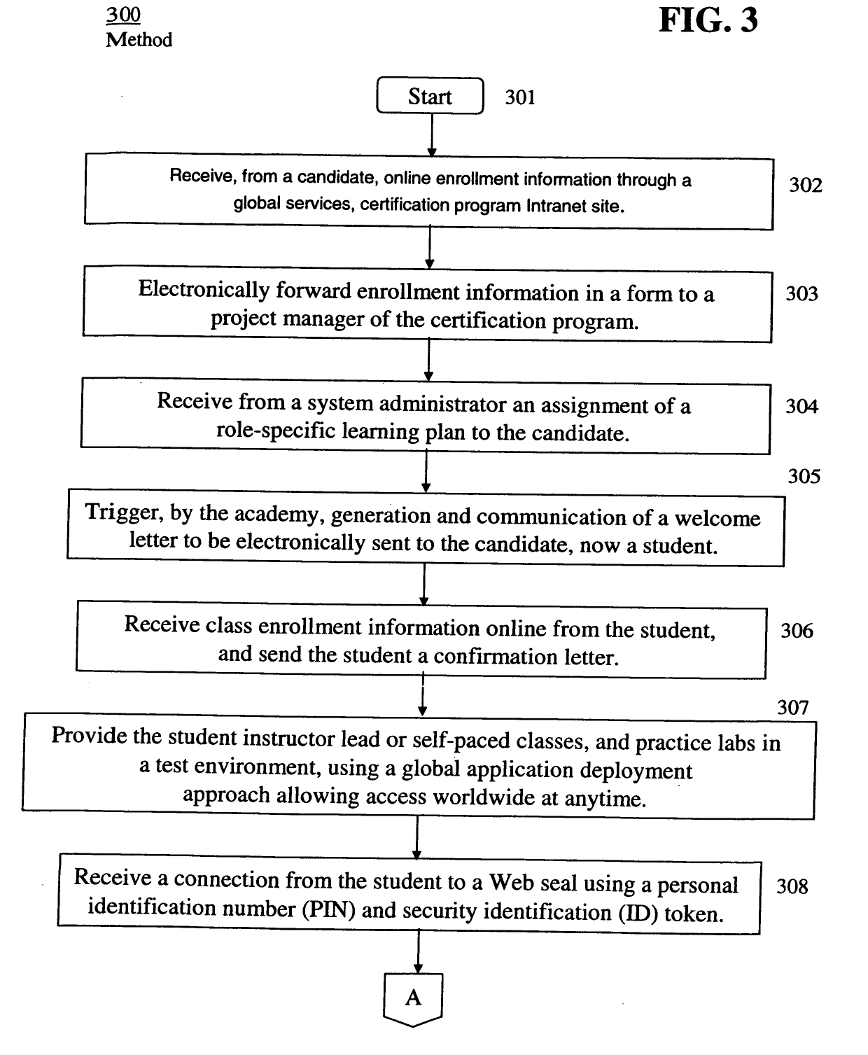

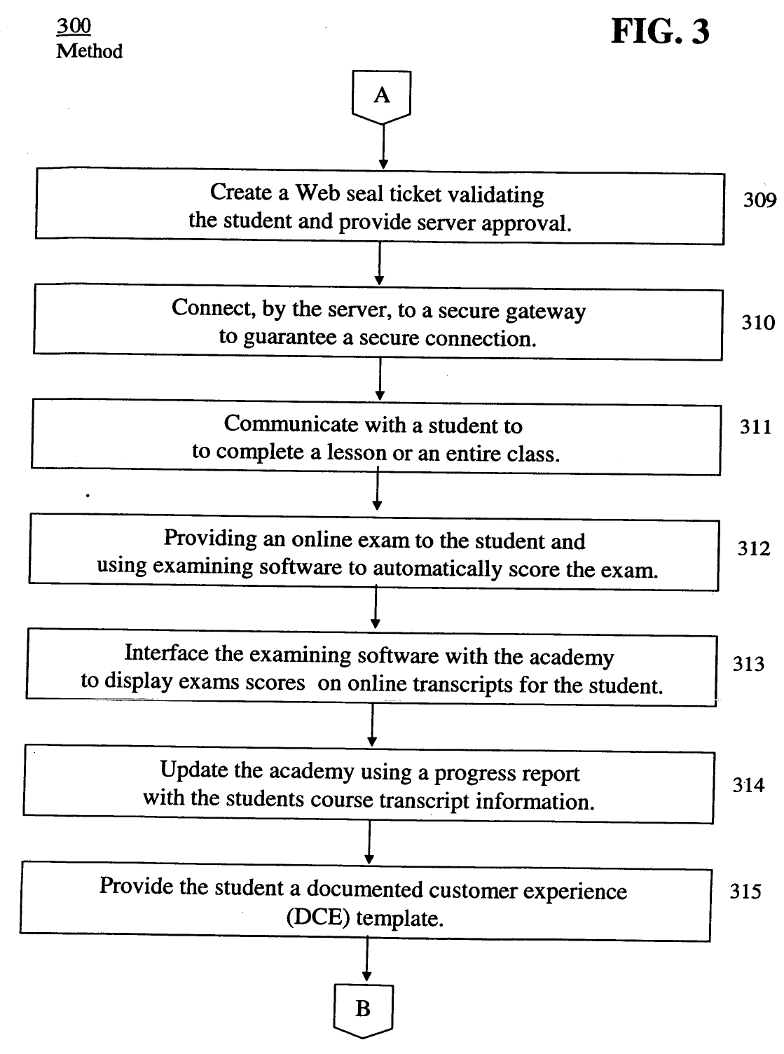

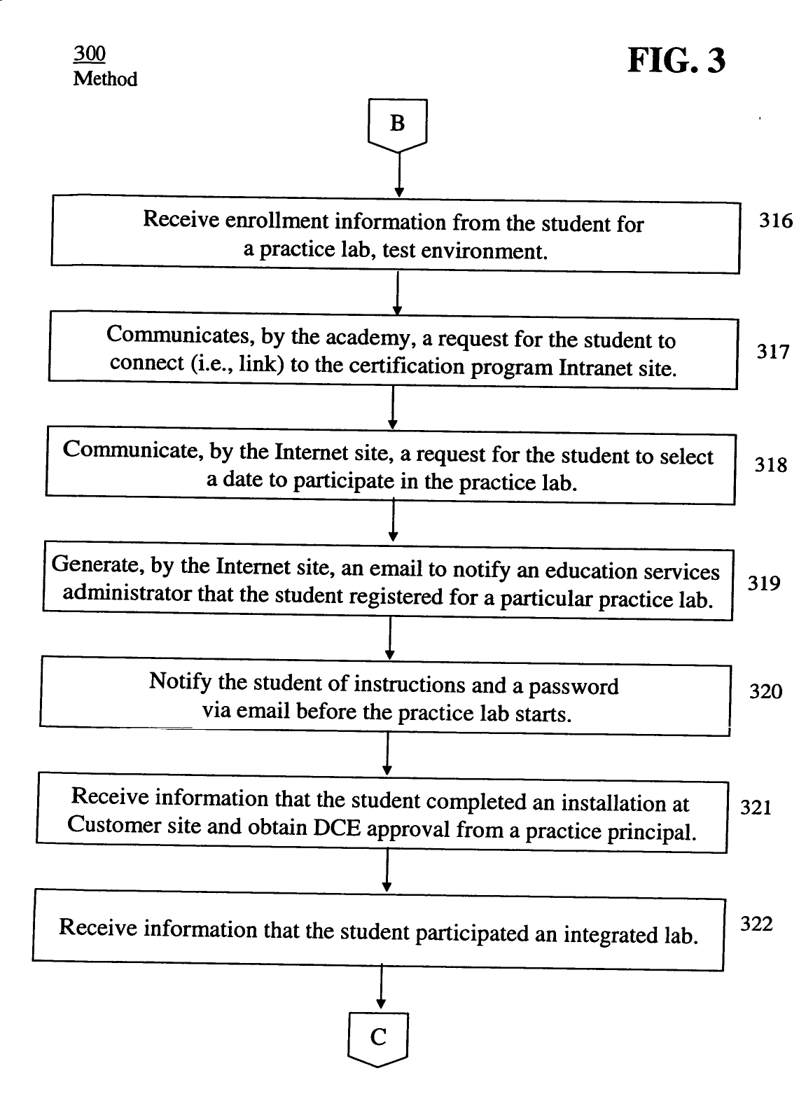

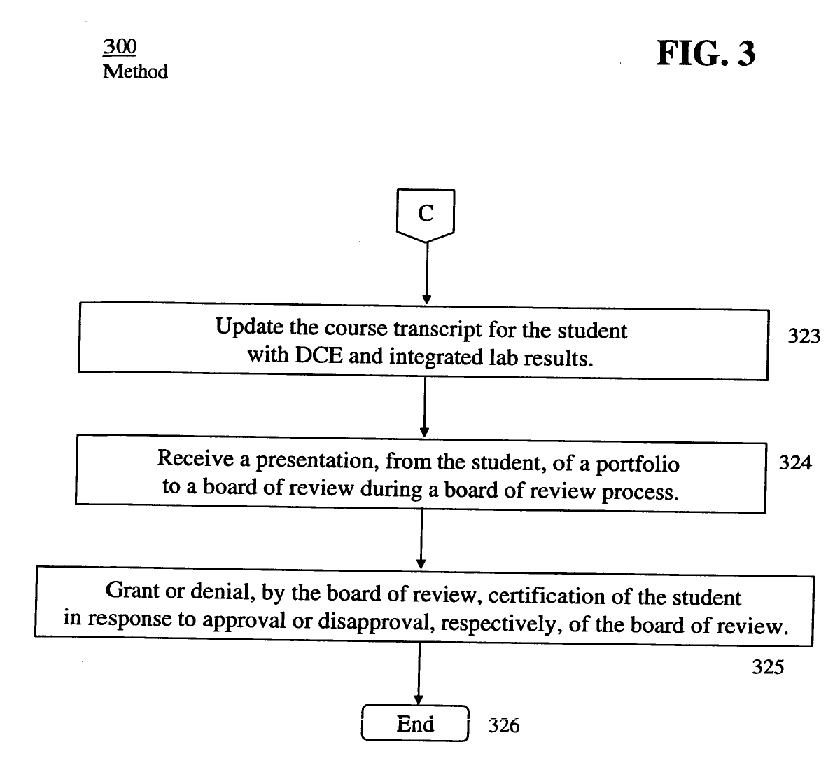

The interface processor 222 communicates with the communication interface 208, for example, to receive user identification information and assigning a role specific learning plan to an identified user, as describe further in FIG. 3. The data processor 224 processes data in the system 200. The assessment processor 226, the monitor processor 228, and the enrollment processor 230 provide assessment, monitoring, and enrollment functions, as described further with reference to FIG. 3. The issue processor 232 issues reports, as described further with reference to FIG. 3. The authorization processor 234, the administration processor 236, and the validation processor 138 provide authorization, administration, and validation functions, as described further with reference to FIG. 3.

The memory 204 stores enrollment information 240, a role specific learning plan 242, test role specific functions 244, the certification program 100, the academy 243 operational role specific functions 246, documented customer experiences (DCE) 248, an executable application 250, a welcome letter 252, class enrollment information 253, an exam 245, confirmation letter 255, a transcript 256, a progress report 258, a ticket 260, a portfolio 262, a personal identification number 264, a competency record 265, and a security identification token 266.

The system 200 may be employed by any type of enterprise, organization, or department, such as, for example, providers of healthcare products and/or services responsible for servicing the health and/or welfare of people in its care. For example, the system 200 represents a hospital information system including financial information. A healthcare provider provides services directed to the mental, emotional, or physical well being of a patient. Examples of healthcare providers include a hospital, a nursing home, an assisted living care arrangement, a home health care arrangement, a hospice arrangement, a critical care arrangement, a health care clinic, a physical therapy clinic, a chiropractic clinic, a medical supplier, a pharmacy, and a dental office. When servicing a person in its care, a healthcare provider diagnoses a condition or disease, and recommends a course of treatment to cure the condition, if such treatment exists, or provides preventative healthcare services. Examples of the people being serviced by a healthcare provider include a patient, a resident, a client, and an individual.

The system 200 may be fixed and/or mobile (i.e., portable), and may be implemented in a variety of forms including, but not limited to, one or more of the following: a personal computer (PC), a desktop computer, a laptop computer, a workstation, a minicomputer, a mainframe, a supercomputer, a network-based device, a personal digital assistant (PDA), a smart card, a cellular telephone, a pager, and a wristwatch. The system 200 and/or elements contained therein also may be implemented in a centralized or decentralized configuration.

The communication path 210 (otherwise called network, bus, link, connection, channel, etc.) represents any type of protocol or data format including, but not limited to, one or more of the following: an Internet Protocol (IP), a Transmission Control Protocol Internet protocol (TCPIP), a Hyper Text Transmission Protocol (HTTP), an RS232 protocol, an Ethernet protocol, a Medical Interface Bus (MIB) compatible protocol, a Local Area Network (LAN) protocol, a Wide Area Network (WAN) protocol, a Campus Area Network (CAN) protocol, a Metropolitan Area Network (MAN) protocol, a Home Area Network (HAN) protocol, an Institute Of Electrical And Electronic Engineers (IEEE) bus compatible protocol, a Digital and Imaging Communications (DICOM) protocol, and a Health Level Seven (HL7) protocol.

The user interface 206 permits bi-directional exchange of data with the processor 202. The data input device 216 provides data to the processor 202 in response to receiving input data either manually from a user or automatically from an electronic device, such as a computer. For manual input, the data input device 216 is a keyboard and a mouse, but also may be a touch screen, or a microphone with a voice recognition application, for example. For automatic input, the data input device 216 is a data modem.

The data output device 218 provides data from the processor 202 for use by a user or an electronic device, such as a computer. For output to a user, the data output device 218 is a display that generates display images in response to receiving the display signals from the processor, but also may be a speaker or a printer, for example. For electronic output to an electronic device, the data output device 218 is a data modem. For example, the processor 202 processes the medical image information for reproduction on a display device for viewing by a user.

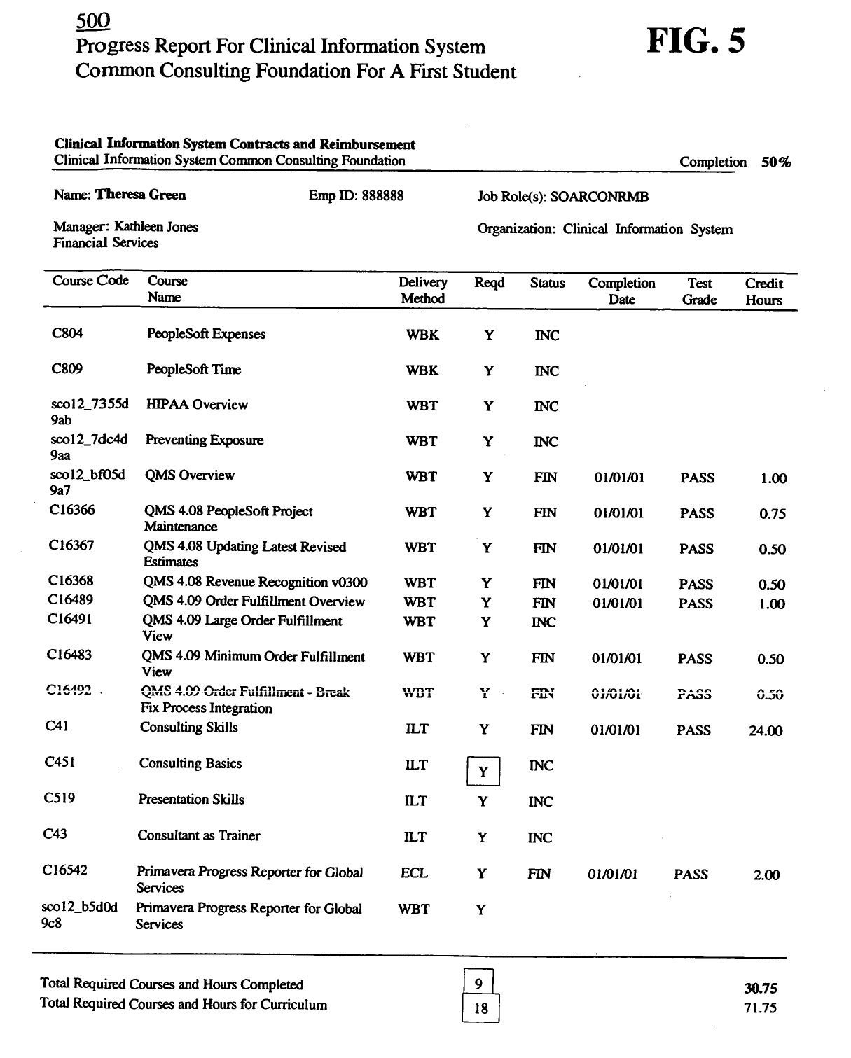

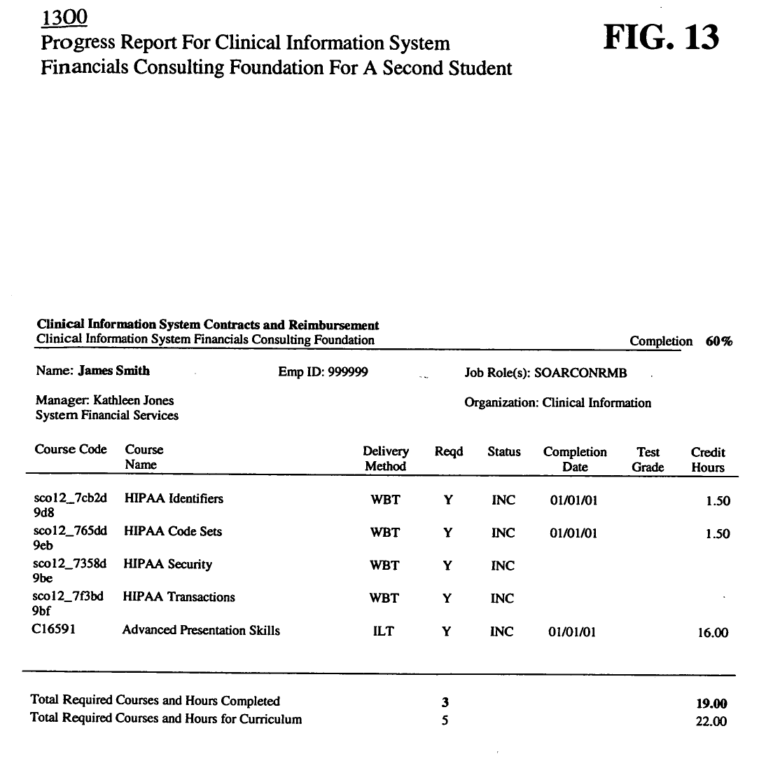

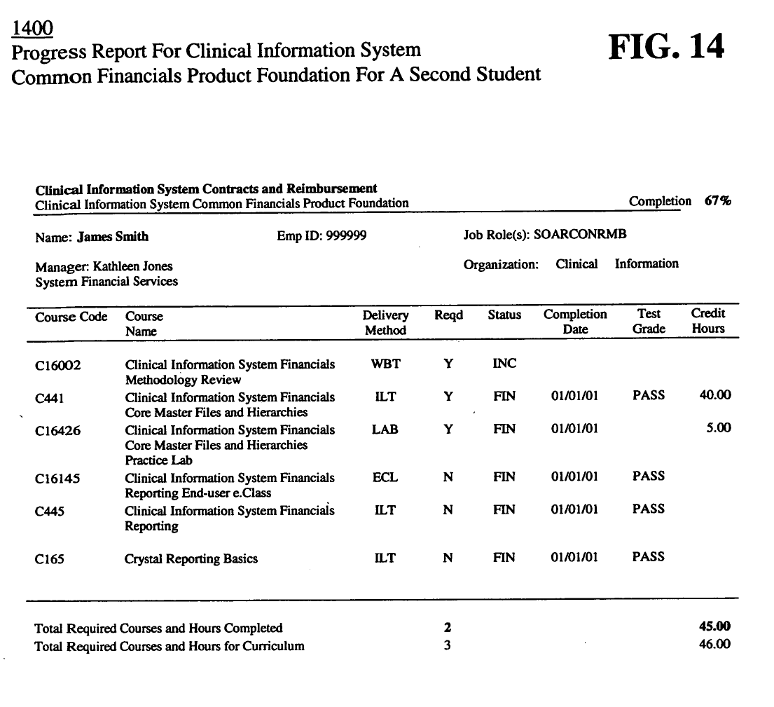

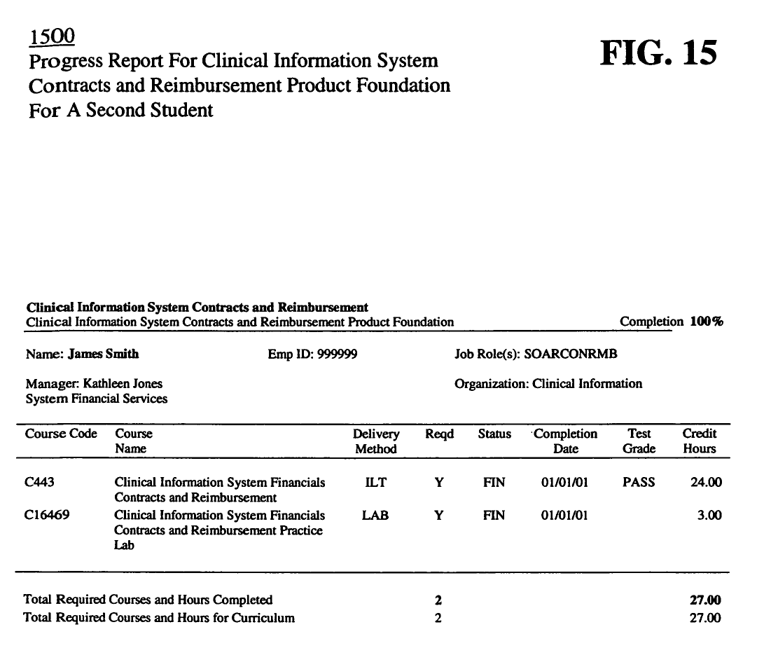

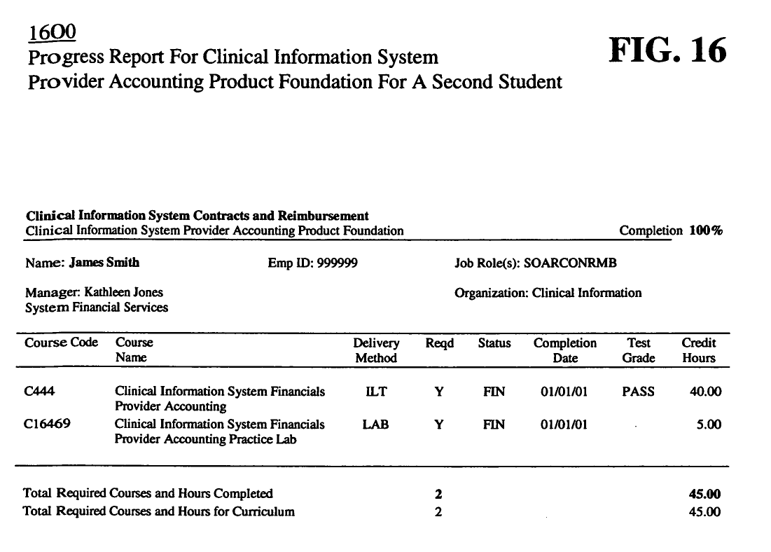

The data output device 218 displays any information stored in the memory 204, such as, for example, one or more of the reports, as shown in FIGS. 5-19. The information stored in the memory 204 is selectable by a user via the data input device 216. The data output device 218 displays any information received from the first 212 or second 214 remote computers.

The data output generator 220 provides an interface between the processor 202 and the data output device 218 for generating display images or portions thereof for display on the data output device 218.

The communication interface 208 provides a boundary across which the system 200 and one or more other independent systems, such as the first remote computer 212 and the second remote computer 214, meet and act on or communicate with each other. The remote computer 212 and the second remote computer 214 represent computer systems of a first student and a second student, respectively, that interact with the system 200, via the communication interface 208.

The memory 204 represents one or more numbers and/or types of repositories, databases, or data storage devices, such as, for example, read only memory (ROM) and/or random access memory (RAM).

The executable application 250 comprises code or machine readable instruction for implementing predetermined functions including, for example, those of an operating system, a software application program, a healthcare information system, or other information processing system, for example, in response user command or input. An executable procedure is a segment of code (i.e., machine readable instruction), sub-routine, or other distinct section of code or portion of an executable application for performing one or more particular processes, and may include performing operations on received input parameters (or in response to received input parameters) and providing resulting output parameters. A calling procedure is a procedure for enabling execution of another procedure in response to a received command or instruction. An object comprises a grouping of data and/or executable instructions or an executable procedure.

The first executable application 250, implemented with embedded (i.e., integrated) or stand-alone (i.e., independent) browsers hosting web-based applications, for example, communicate with and receive information from the first 212 and second 214 remote servers, respectively, in a client-server relationship.

The system 200 and/or elements contained therein may be implemented in hardware, software, or a combination of both, and may include one or more processors. The processor 202 is a device and/or set of machine-readable instructions for performing task. The processor 202 includes any combination of hardware, firmware, and/or software. The processor 202 acts upon stored and/or received information by computing, manipulating, analyzing, modifying, converting, or transmitting information for use by an executable application or procedure or an information device, and/or by routing the information to an output device. For example, the processor 202 may use or include the capabilities of a controller or microprocessor.

The system 200 is a multi-tiered process developed for eligible candidates based on specific system technology and implementation methodology. The system 200 automatically administers and tracks progress.

The system 200 provides a certification program, for example, having three different skill levels of certification for three different types of candidates. The highest level (e.g., level 1) is designed for service provider consultants. The mid-level (e.g., level 2) is designed for selected service provider, business partners. The base level (e.g., level 3) is for service provider customers.

The certification program, for example, is a clinical information system specific and healthcare specific. The service provider academy 243 (FIG. 2) provides the technology to track and report the status of each candidate in the program. Security, combined with global application deployment, enables approved users to access the system 200 from anywhere in the world at any time, with a secure connection.

The highest level of certification, for example, requires that a service provider consultant pass with at least an 80% score on role-based learning plans having approximately 170 hours of system application and professional development classes, in addition to mandatory participation in practice labs, mandatory completion of the documented customer experience, the successful completion of at least one installation, passing a rigorous integrated lab event, and successfully presenting and defending a portfolio before a board of review.

The mid-level certification requires, for example, that a selected service provider, business partner pass with at least an 80% score on role-based system application classes, in addition to participation in practice labs, and successfully completing the board of review.

The base level certification requires, for example, that a customer candidate pass the required system application classes.

FIG. 3 illustrates a method 300 for the certification program 100, as shown in FIG. 1, and for the system 200, as shown in FIG. 2.

At step 301, the method starts.

Steps 302 to 306 relate to the system 200 receiving enrollment information from a candidate, and providing confirmation of the enrollment information to the candidate.

At step 302, the system 200 receives, from a candidate, online enrollment information 240 for a certification program, supported by an Intranet site providing global services. Such information includes, for example, the candidate's biographical information (e.g., name, address), selection of a particular certification program (e.g., program, date, time), and past certification programs completed.

At step 303, the system 200 formats the received online enrollment information 240 (e.g., a form), and electronically forwards the formatted online enrollment information to a project manager of the certification program. The form presents the enrollment information into a standard readable format that is easy to read and understand. The project manager manages the certification program, and performs duties including, for example, reviewing enrollment information, adding and deleting enrollment of candidates, and staffing certification programs.

At step 304, the system 200 receives, from an administrator (e.g., the project manager), data representing an assignment of a role-specific learning plan 242 for the candidate. The system administrator uses an academy 243 (FIG. 2) to assign the candidate the role-specific learning plan 242 for the certification program 100. The academy 243 (FIG. 2) includes a collection of certification programs 100 provided to the candidates. The certificate program 100 includes a collection of role-specific learning plans 242. Hence, completing and gaining proficiency in one or more role-specific learning plans 242 leads to certification in a particular program 100. The academy 243, the certification program 100, the role-specific learning plans 242, and classes together form a training and education process managed by the system 200.

A healthcare provider, in particular, employs a role specific learning plan that includes two or more of the following: (a) initiating placement of an order for treatment to be administered to a patient, (b) creating a workflow sequence of tasks supporting healthcare delivery, and (c) adapting a displayed image window (displayed by the data output device 218) to a desired layout for use in supporting healthcare delivery. Further, a user's exercise of role specific functions employs patient data created to exclude information identifying real patients. The roles may be associated with one or more of the following: (a) a nurse, (b) a physician, (c) a laboratory technician, and (d) an administrator.

At step 305, the system 200 triggers the generation and communication of a welcome letter 252 to be electronically sent from the academy 243 (FIG. 2) to the candidate. Upon welcoming the candidate to the academy, the academy now considers the candidate a student of the academy in a certificate program. The letter includes information, for example, a welcome to the academy, confirmation of receipt of the enrollment information 240, and confirmation of the certification program that the student enrolled in.

At step 306, the system 200 receives class enrollment information 253 (e.g., date, time, instructor) from the student online through the Academy. The role specific learning plan 242 includes one or more classes. After receiving the class enrollment information 253, the system 200 triggers a confirmation letter 255 to be sent from the academy to the student. The confirmation letter 255 includes information, for example, confirmation of receiving class enrollment information received from the student. The system 200 automatically enrolls the student in a particular class, in a particular role specific learning plan, in a particular certificate program, in the academy.

At step 307, the system 200 provides to the student instructor-led or self-paced classes, and practice labs in a test environment, using a global application deployment approach (e.g., the Internet) allowing access worldwide at anytime. The practice lab provides online training of one or more aspects of a system in a test environment. The practice lab provides the student with test role specific functions 244 to exercise the student's abilities in the test environment. The test environment is a simulation or an example of an operational environment. The operational environment is a true, live, in service, real-time, working environment. The test environment advantageously permits the student to be educated and trained in an environment that looks and acts like the operational environment, without the consequences associated with errors and lack of judgment made in the operational environment. Hence, the student can learn, practice, train, and even experiment in the test environment, without penalty, before the student is expected to work in the operational environment.

Steps 308 to 310 relate to the system 200 providing a secure communication link between the student's remote computer 212 and the system 200.

At step 308, the system 200 receives a connection from the student's remote computer 212 to a Web seal, using a personal identification number (PIN) 264 and security identification (ID) token 266. The Web seal provides a first level of communication security between the system 200 and the student's remote computer 212. The PIN 264 and the security identification (ID) token 266 comprise authorization information provided to the student in response to the student's enrollment. Web seals define standards for data handling, privacy, security, and other important areas of a web site policy. A web site bearing a web seal has been accredited, by the web seal issuer, to conform to a certain standard.

At step 309, the system 200 creates a Web seal ticket 260 validating the student's PIN 264 and security ID token 266, and providing approval of a server in the system 200.

At step 310, the system 200 connects, by the server, to a secure gateway (not shown in FIG. 2). The secure gateway provides a second level of communication security between the system 200 and the student's remote computer 212 to ensure a secure connection.

At step 311, the system 200 communicates with the first remote computer 212 permitting the student to complete a lesson or an entire class.

At step 312, the system 200 communicates with the first remote computer 212 permitting the student to complete an online exam 254. The system 200 uses examining software to automatically score the exam. The online exam 254 includes, for example, multiple choice or true/false questions, questions requiring a narrative answer, questions requiring an analytical answer, and/or problems requiring interface with the test environment.

At step 313, the system 200 interfaces the examining software with the academy to display exams scores in an online transcript 256 for the student. The transcript 256 is a record, maintained by the academy, of the classes, role specific learning plans, and certification programs completed by the student.

At step 314, the system 200 updates the academy using a progress report 258 with the student's course transcript information. The progress report 258, otherwise called a proficiency report, is a record, maintained by the academy, of the student's proficiency (i.e., completion, effectiveness, performance) achieved in the classes, role specific learning plans, and certification programs.

At step 315, the system 200 communicates with the first remote computer 212 to provide the student a documented customer experience (DCE) template 248. The student completes the DCE template and sends it back to the system 200. The DCE template 248 permits the administrators of the certification program to receive feedback from the student regarding the student's experience in the online certificate program.

Steps 316 to 320 relate to the system 200 communicating with the student's remote system 212 to permit the student to interact with a practice lab.

At step 316, the system 200 receives enrollment information from the student's remote system 212 for a practice lab through the academy. For example, the student enrolls for the practice lab environment, after the student completes and achieves a predetermined level of proficiency in one or more classes or a role specific learning plan. Therefore, the system 200 permits the student to practice in the practice lab what the student has learned.

At step 317, the system 200 communicates, via the academy, a request to the student for the student to connect (i.e., link) to the certification program Intranet site.

At step 318, the system 200 communicates, via the Internet site, a request to the student for the student to select a date to participate in the practice lab.

At step 319, the system 200 generates, via the Internet site, an email to notify an education services administrator that the student registered for a particular practice lab.

At step 320, the system 200 notifies the student of instructions and a password via email before the practice lab starts.

At step 321, the system 200 receives information that the student completed an installation at customer site and obtain DCE approval from a practice principal. Practice principles use automated progress reports to identify education needs of consultants and set performance expectations. The practice principle provides DCE approval when the student meets the performance expectations.

At step 322, the system 200 receives information that the student participated in an integrated lab event. The integrated lab may be instructor-lead or student self-paced. The integrated lab provides online training of one or more aspects of a system in an operational environment. The integrated lab provides the student with operational role specific functions 246 to exercise the student's abilities in the operational environment. Preferably, a supervisor monitors the student so that the supervisor could manually inhibit or undo student actions that are harmful to operation of the system 200. Alternatively, the system 200 may automatically inhibit or undo student actions that are harmful to operation of the system 200. The operational environment advantageously permits the student to prove skills and proficiency in a live environment.

At step 323, the system 200 updates the course transcript 256 for the student with DCE 248 and integrated lab results.

At step 324, the system 200 receives a presentation, from the student, of a portfolio 262 to a board of review during a board of review process. The portfolio 262 is a collection of one or more certification programs completed by the student The board of review includes one or more persons or an electronic review program that review certification programs completed by one or more students.

At step 325, the system 200 grants or denies, via the board of review, certification of the student in response to approval or disapproval, respectively, of the board of review.

At step 326, the method 300 ends.

In summary of FIG. 3, the system 200 provides one or more certification programs, for one or more students, having the following features and advantages.
a. Automated tracking of the student's proficiency progress saves time, and provides consistent results for deployment managers, enabling them to make sound business decisions.
b. Practice principles save time in preparing the education needs assessments and performance plans for consultants.
c. Global application deployment allows approved students to access the system 200 from anywhere in the world at anytime, while providing a secure connection.
d. The certification program validates that the consultants can apply domain expertise, process skills, and application expertise with the implementation processes to optimize system workflow driven technology.
e. Application and professional development classes have online, robust exams using browser technology worldwide in a proctored environment to validate learning objectives.
f. Online exams are scored automatically using examination software, and results of exams are automatically displayed on the student's portal and on management reports accessed through the academy.
g. Structured practice labs are available remotely to candidates, any time, anywhere through the global application deployment.
h. A structured, complex integrated lab event provides a final proving ground for the students to demonstrate their blend of application skills and implantation methodology.
i. Role specific learning plans online are automatically displayed on the student's portal and tracked through academy.
j. Multiple instructional delivery methodologies (e.g., instructor lead, web-based, web casts, etc.) are leveraged to facilitate cost effective, quality, just-in-time, training throughout the certification program.

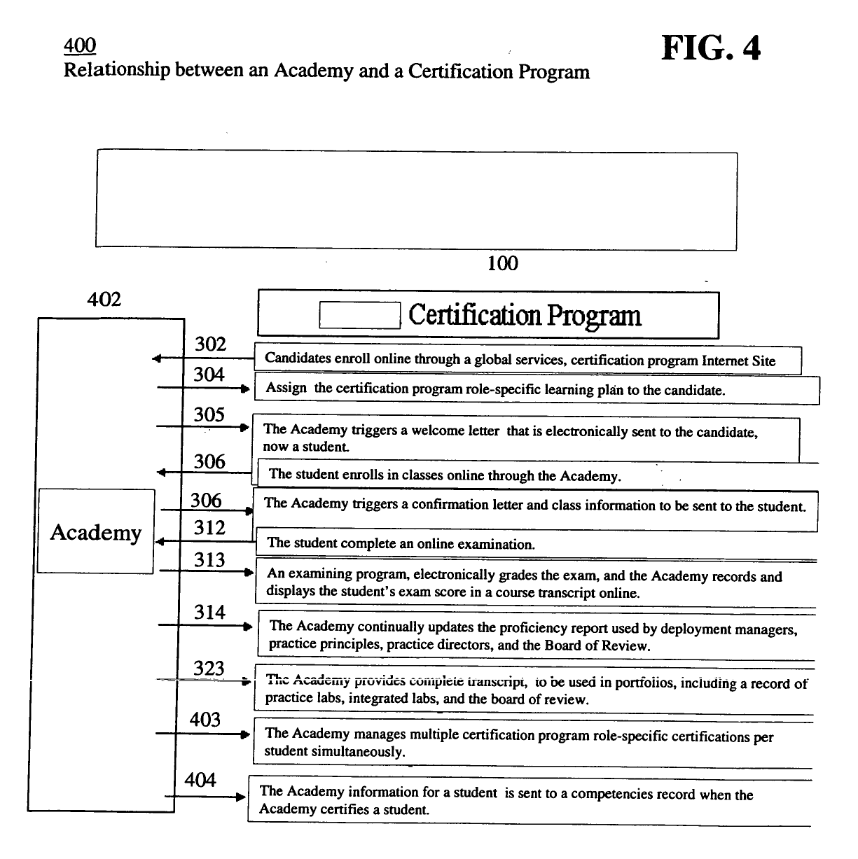

FIG. 4 illustrates a relationship between an academy 402 and the certification program 100, as shown in FIG. 1. The academy 402 administers one or more certification programs 100. Steps 302, 304 to 306, 312 to 314, and 323 are the same as described with reference to FIG. 3. FIG. 4 further includes two additional steps 403 and 404.

At step 403, the system 200, via the academy 402, simultaneously manages multiple certification programs, including multiple role specific plans 242, per student. Hence, the academy 402 performs as a full service educational institution having multiple program offerings for multiple students.

At step, 404, the system 200, via the academy 402, sends certification information to a competency record 265 for the student when the board of review certifies a student. The competency record 265 is a record of one or more certifications completed by the student and approved by the board of review.

As part of the certification process, management typically needs to know which members of their staff are certified (i.e., successful completion of an assigned group of required courses), where they are in the certification process, and the percentage of their staff that are/are not certified. Typically, managers track this kind of information using reports. For example, the reports may indicate a percent of completion for one or more students in the one or more certification programs (e.g., project management, QMS migration). FIGS. 5 to 19 provides examples of these types of reports.

The system 200 produces the reports based on the following assumptions, for example.
a. The reports use tables for table lookup on the report search parameters.
b. Courses are mapped to role specific learning plans on the academy by defining curriculums.
c. Search parameters search by curriculum or course(s), but not both.
d. One or more courses entered as a search parameter are reported as a group.
e. Total duration hours, percent completed by a student, and percent completed by students are determined based on courses requested.
f. A curriculum entered as a search parameter is reported down to any subset curriculum of the entered curriculum, but a parent curriculum of the entered curriculum is not considered.
g. Child curriculums are listed, if the parent curriculum is entered as the search parameter.
h. A secondary job role is a search parameter. A student can be assigned one or more secondary job roles.
i. Students with an active status are included in a report.
j. A percent completion is tracked for each student, per curriculum.
k. A percent completion is tracked for each student, across the curriculums requested for the report.
l. A percent completion is tracked for learners requested across curriculums requested for the report.
m. A percent completion is calculated based on the number of required courses completed, not the course duration.
n. Elective (i.e., not required) courses in a curriculum are displayed on a report, but marked as electives and not included in any calculations. Calculations are based on required courses, as defined in a curriculum catalog.
o. A total number of required hours for the curriculum is derived from the duration field in the curriculum.
p. A total number of completed hours for the curriculum is calculated by adding the duration hours for completed required courses.
q. A student does not get credit for duration hours, nor do the hours display on the report, until the student completes the course (i.e., resulting in a transcript status of finished or exempt), and has passed the associated test (e.g., online or offline).
r. Online tests are post-tests (i.e., taken after a course is completed); one post-test is assigned to a course at any given time.
s. Offline test grades are entered as a letter test grade in the student's transcript.
t. A pass/fail on a test is determined from the letter test grade on the history transcript or the latest test instance for the online post-test.
u. Courses, without tests (i.e., no online tests and no letter test grade), are considered complete, if the transcript status is stated as finished or exempt.
v. Courses, with offline tests, are not marked finished before the letter test grade is entered.
w. Since a student can have more than one finished transcript per course, the completion date for the latest finished transcript will display.
x. If the student does not have a finished or exempt transcript status for a course, the report displays a status of incomplete, with no completion date.
y. Online courses with embedded tests are considered complete, if the transcript status is finished. The system 200 assumes this because a transcript status of finished is not generated until the test within the course is passed.

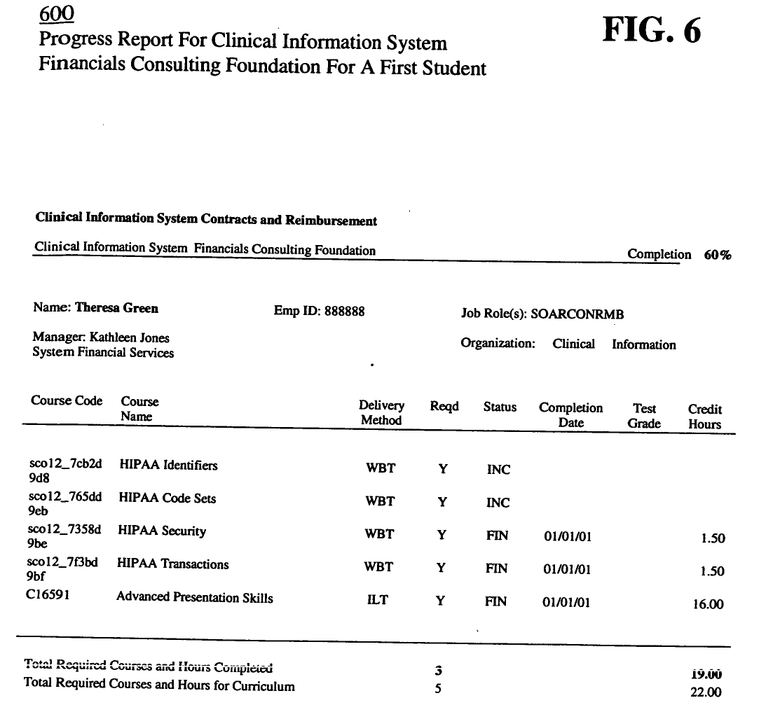

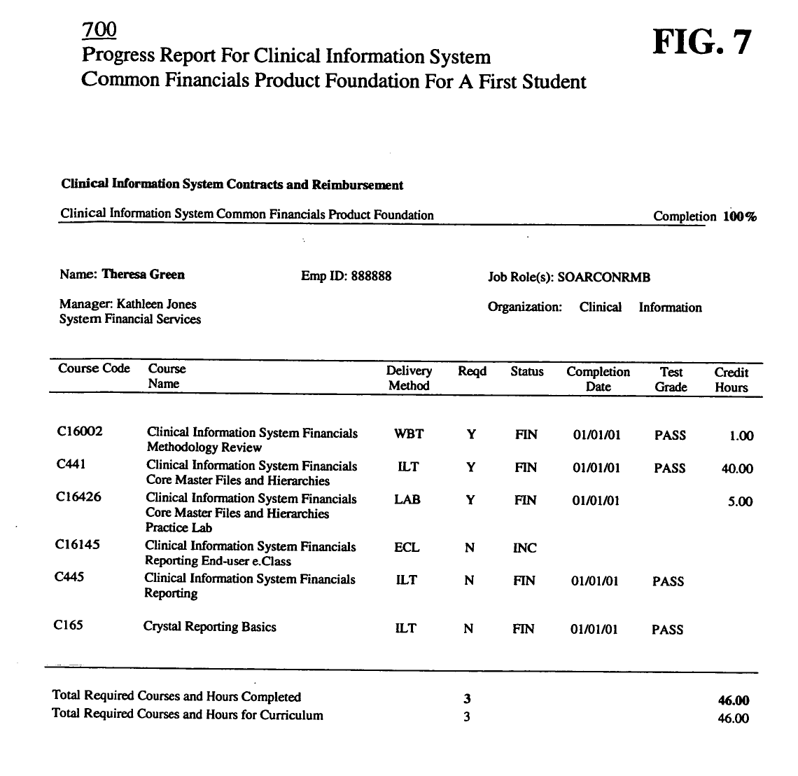

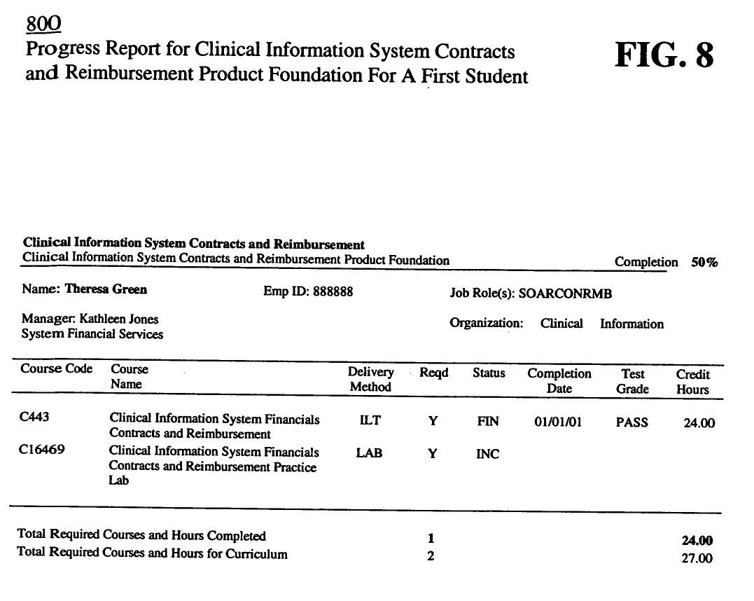

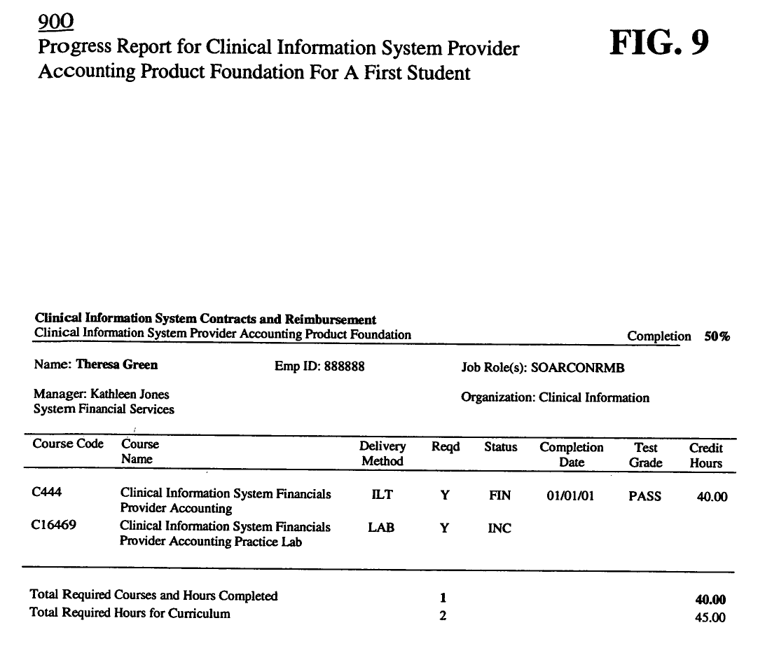

FIGS. 5 to 9 illustrate progress reports for a first student for a certification program, including various role specific learning plans, in a clinical information system. The clinical information system represents the computer information system 200. The contracts and reimbursement system represents a particular certification program. The common consulting foundation (FIG. 5), the financials consulting foundation (FIG. 6), the common financials product foundation (FIG. 7), the contracts and reimbursement product foundation (FIG. 8), and the provider accounting product foundation (FIG. 9) represent the multiple role specific learning plans 242.

Each of the role specific learning plans 242, represented in FIGS. 5 to 9, includes, data fields represented for example, as: student biographical information, course header information, course detail information, course summary information, and percentage of courses completed information.

The student biographical information includes, for example, the student's first and last name (e.g., Theresa Green), employer identification (e.g., 888888), job role name (e.g., soarconrmb), manager's first and last name (e.g., Kathleen Jones), organization name (e.g., clinical information system), and department (e.g., financial services).

The course header information includes, for example, course code, course name, delivery method, an indication whether or not the course is required (e.g., yes or no), a status of whether or not the student completed the course (e.g., incomplete or finished), a completion date, a test grade or result, and course credit hours. The course header information may also include a name of a parent curriculum or a child curriculum.

The course detail information includes detailed information, if available, for each course corresponding to the course header information.

The course summary information includes one or more summaries of the course detail information. For example, a total required course and hours completed, and a total required courses and hours for a role specific learning plan (i.e., a curriculum).

The percentage of courses completed information, located in the upper right hand corner of each of FIGS. 5 to 9, represents a calculation of the number of required courses completed and passed divided by the total number of required courses for the role specific learning plan. For example, in FIG. 5, the number of required courses completed and passed (i.e., 9 courses) divided by the total number of required courses (i.e., 18 courses) for the role specific learning plan equals 50%.

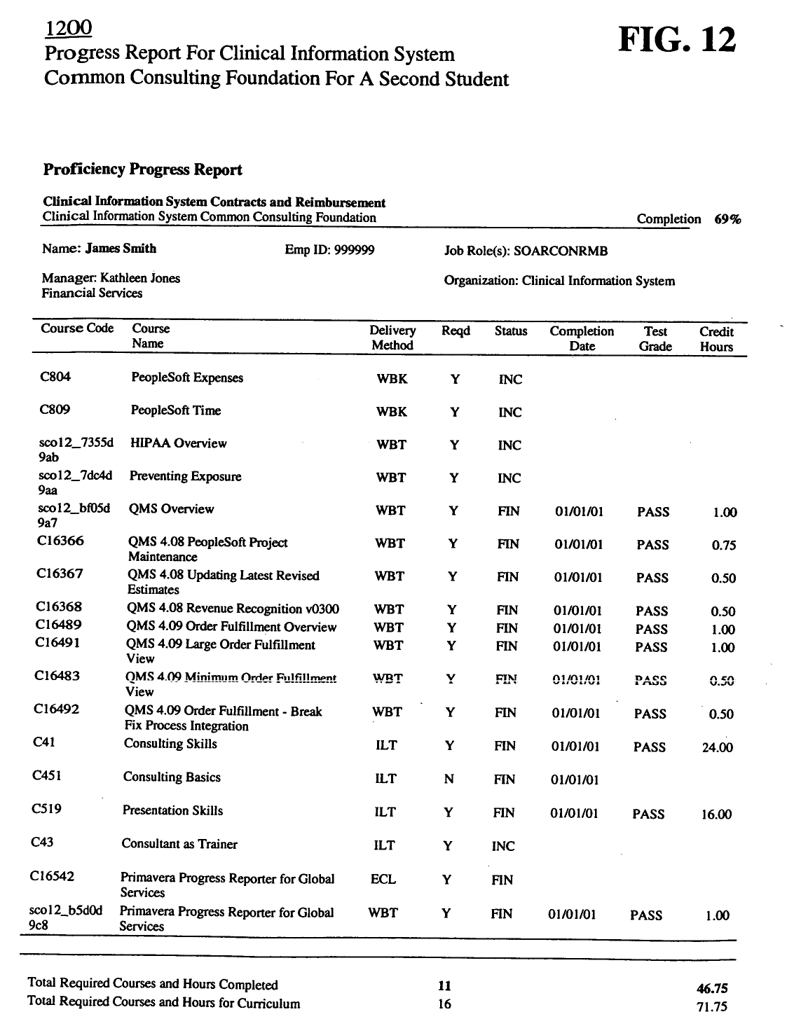

FIGS. 12 to 16 illustrate progress reports for a second student for a certification program, including various role specific learning plans, in a clinical information system 200 in an analogous manner to that described in FIGS. 5 to 9 for the first student.

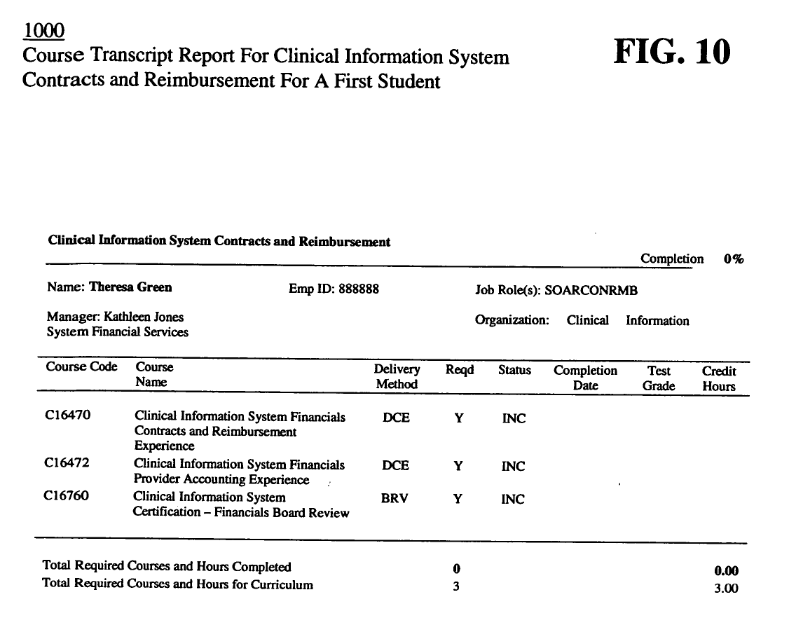

FIG. 10 illustrates a course transcript report 256 for the clinical information system 200 contracts and reimbursement certification program of the first student. The certification program includes, for example, student biographical information, course header information, course detail information, course summary information, and percentage of courses completed information, as described above with reference to FIGS. 5 to 9. The course transcript report 256 may also include additional information describing one or more role specific learning plans that the courses relate to.

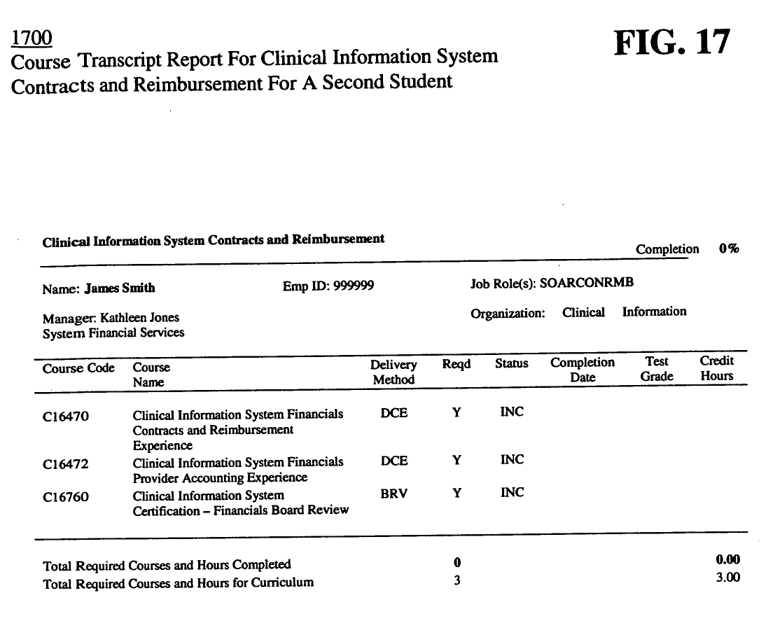

FIG. 17 illustrates a course transcript report 256 for the clinical information system 200 contracts and reimbursement certification program of the second student in an analogous manner to that described in FIG. 10 for the first student.

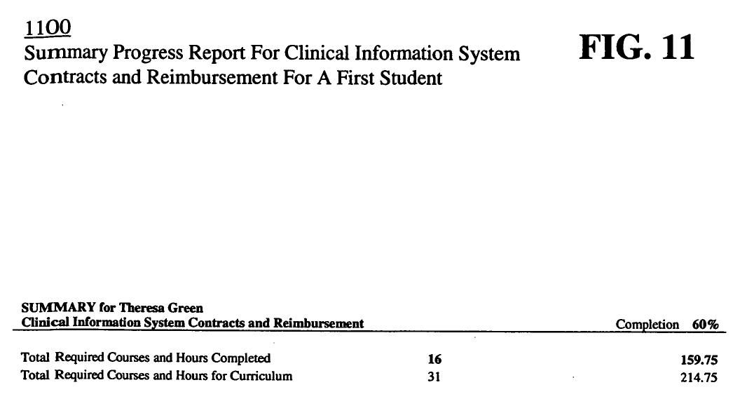

FIG. 11 illustrates a summary report 1100 for clinical information system 200 contracts and reimbursement certification program for the first student. The summary report includes aggregate course detail information and percentage of courses completed information.

The aggregate course detail information includes, for example, total required courses (e.g., 16) and hours (e.g., 159.75) completed, and total required courses (e.g., 31) and hours (e.g., 214.75) for a role specific learning plan (i.e., a curriculum). The percentage of courses completed information (e.g., 60%), located in the upper right hand corner of FIG. 11, represents a calculation of the number of required courses completed and passed (e.g., 16) divided by the total number of required courses (e.g., 31) for the role specific learning plan.

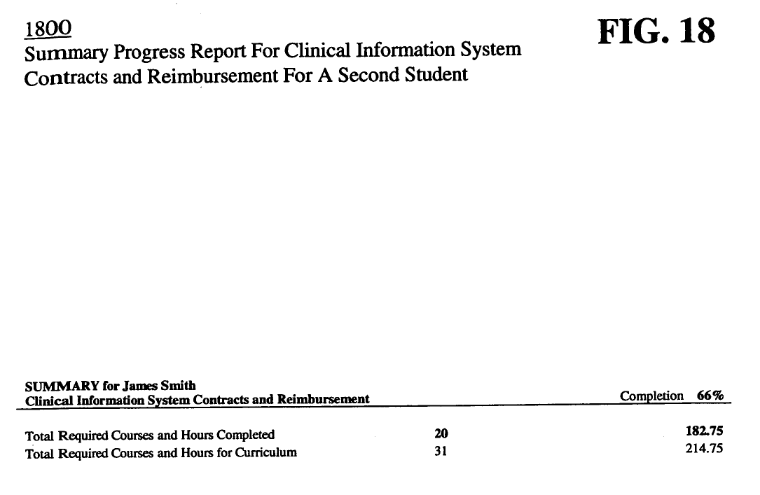

FIG. 18 illustrates a summary report 1800 for clinical information system 200 contracts and reimbursement certification program for the second student in an analogous manner to that described in FIG. 11 for the first student.

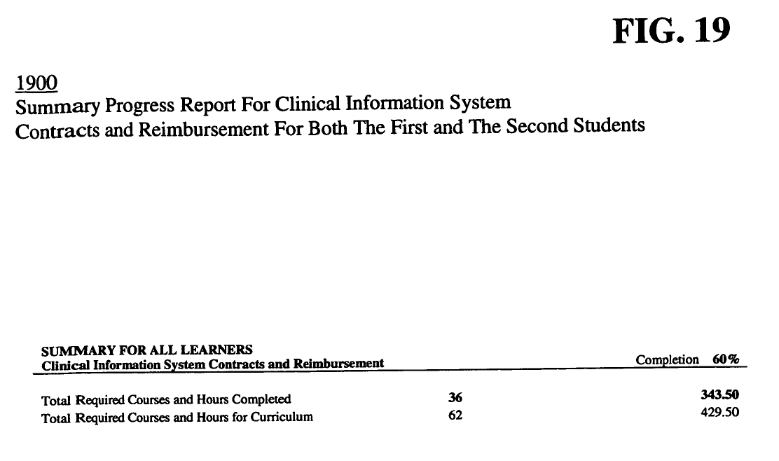

FIG. 19 illustrates summary report 1900 for clinical information system 200 contracts and reimbursement certification program for both the first and second students (e.g. multiple students). The summary report includes aggregate course detail information and percentage of courses completed information for students.

The aggregate course detail information for students includes, for example, total required courses (e.g., 36) and hours (e.g., 343.50) completed, and total required courses (e.g., 62) and hours (e.g., 429.50) for a role specific learning plan (i.e., a curriculum).

The percentage of courses completed information for students (e.g., 60%), located in the upper right hand corner of FIG. 19, represents a calculation of the number of required courses completed and passed (e.g., 36) divided by the total number of required courses (e.g., 62) for the role specific learning plan.

The following text is a more detailed description of how the executable application 250 in the system 200 generates the reports illustrated in FIGS. 5 to 19, for example. Therefore, the following text describes software code and/or procedures to represent the executable application 250.

The search parameters use a table lookup. Examples, of search parameters include one or more of each of the following: a curriculum, a course, a student, an organization, and a manager's job role. The system 200 converts search parameters to student ID (e.g., id_stud) and course ID (e.g., id_crs) lists, according to the following description. Information in the students' table (e.g., named “STUDENTS”) is related to the student's biographical information in the following manner: nm_stud_last corresponds to the student last name, nm_stud_first corresponds to the student first name, id_org corresponds to the student's organization from an organizations' table (e.g., named “ORGANIZATIONS”), id_supervisor corresponds to the student's manager from the students' table, fl_stud_active corresponds to a flag to indicate if the student is active or not (e.g., set to “YES” if active and “NO” if inactive).

The student's organization(s) entered as search parameters may be parent organizations. A parent organization is broken down into the lowest child organizations. The system 200 determines the lowest child organization by considering each id_org entered as a search parameter to an organization hierarchy table (e.g., named “ORG_HIERARCHIES”) as an ID of a parent organization (e.g., Id_org_parent). If one or more records are found, the system 200 makes a list of each child organization (e.g., id_ord_child) for each parent organization (e.g., parent_id_org). Then, the system 200 takes each child organization (e.g., id_org_child) from the list of as the parent organization (e.g., id_org_parent) in the organization hierarchy table (e.g., named “ORG_HIERARCHIES”). The system 200 continues to do this until no more parent records (id_org_parent) are found.

A secondary jobs table (e.g., SECONDARY_JOBS) contains the following relationships to the student. A student's job ID (e.g., id_job) corresponds to a student's secondary job role from a “JOBS” table. A job status (e.g., cd_b status) is set to “active.” Search parameters entered for the student, organization, manager, and job role yield a list of student ID's (id_stud) retrieved from the “STUDENTS” table and the “SECONDARY_JOBS” table.

A courses table (e.g., “COURSES) contains the following relationships to the course: cd_crs corresponds to a course code; nm_crs corresponds to a title of the course; fl_crs_curric corresponds to “true” if course has child curriculum courses associated with it; and no_crs_equiv corresponds to minimum number of child courses that are completed for the curriculum to be considered complete.

A course curriculum table (e.g., COURSE_CURRICS) contains the following relationships to the course: id_crs_parent corresponds to the parent curriculum, course code; id_crs_child corresponds to the child course assigned to the parent; and fl_cc_required corresponds to the course being required in the curriculum, if true.

If the search is by curriculum, the system 200 takes the id_crs entered as a search parameter and examines the course curriculum table (e.g., COURSE_CURRICS), and looks for a match on a course curriculum ID (e.g., id_crs_cur). The system 200 gets a list of id_crs_child courses associated with id_crs_cur. This list represents the child courses that are part of the curriculum. Each id_crs_child is checked in the “COURSES” table for the fl_crs_curric flag being set to “true.” This happens because the curriculum entered as a search parameter may have child curriculums under it. If the fl_crs_curric flag is set to true, the system 200 gets a list of child courses (e.g., id_crs_child) from the course curriculum table (e.g., COURSE_CURRICS).

Searching by curriculum yields a list of id_crs from the “COURSES” table grouped by the lowest level curriculum. This means a curriculum entered as a search parameter can be comprised of many child curriculums. The system 200 groups the report by the lowest level child curriculums for each curriculum entered as a search parameter, for example.

If searching by curriculum yields a list of the lowest level parent curriculums along with the minimum number of child courses that are completed for the curriculum to be considered complete. The system 200 lists each child course within each parent curriculum with whether or not it is required in the curriculum.

If the system 200 searches by entered course(s) search parameters, the system 200 yields a list of course ID's (e.g., id_crs) from a courses table (e.g., named COURSES). The courses entered comprise a single group on the report.

The system 200 retrieves data from a transcripts table (e.g., TRANSCRIPTS). For each student ID (e.g., id_stud) from the student list, the system 200 retrieves a record from the “TRANSCRIPTS” table to match a course ID (e.g., id_crs) from the course list, wherein the transcript status code (e.g., cd_trn_status) is “finished” or “exempt”. If the system 200 finds a record, the system 200 displays the course status on the report as FIN or EXE and the system displays a transcript status date (e.g., dt_trn_status). If more than one “finished” or “exempt” transcript records are found, the system 200 retrieves the record with the most current dt_trn_status. If the system 200 does not find a record, the system 200 displays course status as incomplete (e.g., INC), no completion date is displayed, no duration is displayed and no test grade is displayed.

The system 200 displays data on the report, according to the following description. The system 200 pulls out the following fields from the UTRANSCRIPTS” table for eligible records.

Student's first name—id_stud corresponding to the “STUDENTS” table for nm_stud_first.

Student's last name—id_stud corresponding to the “STUDENTS” table for nm_stud_last.

Student's employee ID—id_stud corresponding to the “STUDENTS_EXT” table employee ID.

Student's organization—id_stud corresponding to the “STUDENTS” table for id_org.

Student's secondary job(s)—id_stud corresponding to the “SECONDARY_JOBS” table for id_job(s).

Student's manager name—id_stud corresponding to the “STUDENTS” table for id_supervisor.

Course code cd_crs.

Course name—id_crs to COURSES table for nm_crs.

Course delivery method—id_crs to COURSES_EXT table for delivery method.

Credit hours—id_trans to TRANSCRIPTS_EXT table for duration.

Required—id_crs to COURSE_CURRICS for fl_cc_required (by curriculum).

Course Status—cd_trn_status. If F, display FIN. If E, display Exempt. If no F or E, display INC.

Status date—dt_trn_status if cd_trn_status equal F or E.

Test Grade (Pass, Fail, Incomplete)—cd_trn_test (see below).

The system displays paper test results, according to the following description. If cd_trn_test is valued, it means the course has a paper test. For example, if the cd_trn_test=“passed,” the test grade displays “PASS” in a report, the duration for the course is displayed under credit hours, and the duration for the course is counted in the hours completed for the student. If the cd_trn_test=“incomplete” or “failed,” the test grade displays as “INC” or “FAIL,” respectively. The system 200 does not display credit hours and the duration for the course is NOT counted in the hours completed for the student. However, the system 200 displays the duration, if the transcript status is “Finished” or “Exempt,” and the grade is “Passed,” if there is a test. Further, if the system 200 reports by course, the system 200 does not display a curriculum name or a required column on a report.

The system displays online test results, according to the following description. If cd_trn_test is null, the system 200 does not enter a paper assessment grade for the student. The system 200 checks whether there is an online test associated with the course. The system 200 makes this determination by comparing id_crs to the “COURSE_TESTS” table. If there are one or more records, it means there are online tests associated with this course. The system 200 retrieves id_test for each record matching id_crs and goes to the “TESTS” table. The system 200 checks to make sure that the cd_test_type=“post test.” For those id_test where cd_test_type=“post test,” the system 200 pulls out no_test_masteryscore. Note that the system 200 assumes that one post-test is associated with a course at one time.

The system 200 addresses the “TEST_INSTANCES” table with id_test and id_stud. If there are one or more records in the “TEST_INSTANCES” table, it means the student has taken an online post-test for this course. The system 200 retrieves the no_test_score on the record where trn_test_taken is the latest date and time. If no_test_score is equal to or greater than no_test_masteryscore, the system 200 prints “PASS,” displays the duration for the course under credit hours, and the duration for the course is counted in the hours completed for the learner. If no_test_score is less than no_test_masteryscore, the system 200 prints “FAIL,” no credit hours are displayed, and the duration for the course is NOT counted in the hours completed for the learner.

If the system 200 determines that there are no records in the “TEST_INSTANCES” table with id_test and Id_stud it means the student has NOT taken the post-test for this course yet. The system 200 prints “Incomplete” as the test grade, no credit hours are displayed, and the duration for the course is NOT counted in the hours completed for the student.

The system 200 displays completion for courses with no test, according to the following description. If the system 200 determines that there is no paper test associated with the course and no online test associated with the course, the system 200 displays nothing for the test grade. If the system 200 determines that the transcript status of a course with no test is “Finished” or “Exempt,” the system 200 displays the duration for the course under credit hours, and the duration for the course is counted in the hours completed for the student.

The system 200 displays the total required hours completed on the report, according to the following description. The total required hours is the sum of the credit hours for each required course in the curriculum the student has completed. Completion implies the student has a course status of “Finished” or “Exempt,” and a test grade of “Passed” for courses with a test. Further, the system 200 displays the total credit hours for the curriculum, which is stored as duration for the parent curriculum course in the “COURSES_EXT” table.

The system 200 sorts the data on the report, according to the following description.

By curriculum: primary sort—curriculum name entered as search parameter (parent); secondary sort—student last name within each child curriculum; and tertiary sort—course name as sequenced in curriculum. By course: primary sort—student last name; and secondary sort course name.

The system 200 displays the percentage completed on the report, according to the following description. The system 200 displays the percentage completed for each student for each curriculum or course(s). If the search is by curriculum, the percentage completed equals the total number of required courses completed by student for the curriculum divided by the a minimum number of child courses that are completed for the curriculum to be considered complete minus the number of courses not required, and multiplied by one hundred.

If the search is by course(s) the percentage completed equals the total number of courses completed by the student divided by the total number of courses, and multiplied by one hundred. The system 200 displays the percentage completed for each student for curriculums, if the report is by curriculum. The percentage completed equals the sum of the total number of required courses completed by the student for curriculums divided by the (sum of (the total number of minimum number of child courses that are completed for the curriculum to be considered complete minus the number of courses not required) for curriculums) multiplied by one hundred.

The system 200 displays the percentage completed for student for curriculums or course(s). If the search is by curriculum, the percentage completed equals the sum of the total number for required courses completed for students for curriculums divided by the (sum of the (total number of minimum number of child courses that are completed for the curriculum to be considered complete minus the number of courses not required) for students for curriculums) multiplied by one hundred. If the search is by course(s), the percentage completed equals the total number of courses completed by students divided by the total number of courses multiplied by the total number of learners, and multiplied by one hundred.

The system 200 and method 300 provide the following advantages.

The global application deployment approach (e.g., Internet) permits approved consultants worldwide to access the system 200 to receive training and education in test and operational system environments.

The system 200 trains the consultant's in a consistent, robust environment leading to the high quality consulting skills.

The system 200 raises the consultant's performance level by ensuring that the consultants are well trained, knowledgeable, and highly skilled to perform their jobs successfully.

The system 200 ensures that the consultants are recognized as a leader and service provider in system implementation consulting.

The automatic, real-time, online, progress reports, provide up-to-date results anytime, anywhere for certification program personnel and students permitting timely business decisions.

The satisfaction of the system's customers increases because the system 200 is a formal, structured program that tracks and reports, via the academy, students' competencies through rigorous exams and in test and operational system environments.

The system 200 trains consultants on an implementation methodology that provides an efficient and timely implementation process, which results in accelerated cash flow and revenue recognition for the system's customers.

The system 200 incorporates the functions of the academy to perform automated, online recording results of exams, compilation of transcripts, and management of competency reports.

The certification program validates the consultant's ability to blend and apply professional development skills, system domain expertise, and application proficiency.

Hence, while the present invention has been described with reference to various illustrative embodiments thereof, the present invention is not intended that the invention be limited to these specific embodiments. Those skilled in the art will recognize that variations, modifications, and combinations of the disclosed subject matter can be made without departing from the spirit and scope of the invention as set forth in the appended claims.

What is claimed is:

1. A method for providing an on-line educational course concerning operation of a computerized information system, comprising the activities of:
receiving user identification information;
assigning a role specific learning plan to an identified user;
supporting user exercise of role specific functions of a particular computerized information system in a test environment to accomplish predetermined objectives;
supporting user exercise of corresponding role specific functions of said particular computerized information system in an operational environment to accomplish said predetermined objectives; and
assessing a user proficiency level in accomplishing said predetermined objectives.

2. A method according to claim 1, wherein
said particular computerized information system is a clinical information system used in delivering healthcare to a patient, and including the activity of:
supervisory monitoring said user exercise of corresponding role specific functions of said particular computerized information system in said operational environment.

3. A method according to claim 2, wherein
said activity of supervisory monitoring comprises enabling inhibiting of actions harmful to operation of said clinical information system in said operational environment.

4. A method according to claim 2, wherein
said activity of supervisory monitoring comprises automatic inhibiting of actions harmful to operation of said clinical information system in said operational environment.

5. A method according to claim 2, wherein
said clinical information system supports healthcare associated financial information processing.

6. A method according to claim 1, wherein
said particular computerized information system is a clinical information system used in delivering healthcare to a patient, and
said role specific functions of said particular computerized information system comprise at least two of the following: (a) initiating placement of an order for treatment to be administered to a patient, (b) creating a workflow sequence of tasks supporting healthcare delivery and (c) adapting a displayed image window to a desired layout for use in supporting healthcare delivery.

7. A method according to claim 1, wherein
said user exercise of role specific functions employs patient data created to exclude information identifying real patients.

8. A method according to claim 1, including the activity of:
receiving user-entered data for selecting between, (a) instructor led and (b) user self-paced, exercise of role specific functions.

9. A method according to claim 1, including the activity of:
receiving user-entered data for selecting a role from roles associated one or more of the following: (a) a nurse, (b) a physician, (c) a laboratory technician, and (d) an administrator.

10. A method according to claim 1, including the activities of
enrolling said user in response to said received user identification information,
providing user specific authorization information to a user in response to said enrollment, and
validating said user is authorized to exercise said role specific functions in response to received user specific authorization information.

11. A method according to claim 1, including the activity of
administering an on-line examination to a user in assessing said user proficiency level.

12. A method according to claim 1, wherein said activity of
assessing said user proficiency level includes the activity of receiving supervisor-entered ratings of said user performance in exercising said role specific functions.

13. A program storage device readable by a machine, tangibly embodying a program of instructions executable by the machine to perform the method activities of claim 1.

14. A method according to claim 1, including the activity of:
initiating issue of certification said user has met proficiency requirements for operation of said computerized information system in response to said assessment of said user proficiency level.

15. A system for providing an on-line educational course concerning operation of a computerized information system, comprising:
an interface processor for receiving user identification information and assigning a role specific learning plan to an identified user;
a data processor for,
supporting user exercise of role specific functions of a particular computerized information system in a test environment to accomplish predetermined objectives;
supporting user exercise of corresponding role specific functions of said particular computerized information system in an operational environment to accomplish said predetermined objectives; and
an assessment processor for assessing a user proficiency level in accomplishing said predetermined objectives.
